(19) United States
(12) Patent Application Publication
(10) Pub. No.: US 2013/0222519 A1
(43) Pub. Date: Aug. 29, 2013

(54) MOBILE DEVICE CAPABLE OF MULTI-PARTY VIDEO CONFERENCING AND CONTROL METHOD THEREOF

(71) Applicant: Pantech Co., Ltd., (US)

(72) Inventors: In Ho LEE, Seoul (KR); Jong Hwa CHOI, Seoul (KR); Seung Youl HEO, Gwangmyeong-si (KR)

(73) Assignee: PANTECH CO., LTD., Seoul (KR)

(21) Appl. No.: 13/705,856

(22) Filed: Dec. 5, 2012

(30) Foreign Application Priority Data
Feb. 29, 2012 (KR) 10-2012-0021502

(51) Int. Cl. H04N 7/15

(52) U.S. Cl. CPC H04N 7/15
USPC 348/14.02

(57) ABSTRACT

A mobile device to control a multi-party video conferencing including a processor to process video data to be sent to a counterpart mobile device participating in the multi-party video conferencing and to transmit the processed video data to the counterpart mobile device, and a control unit to select a counterpart mobile device to authorize a main control right for controlling the multi-party video conferencing among counterpart mobile devices participating in the multi-party video conferencing. A method that uses a processor to determine a main controller of a video conferencing session including determining mobile devices for the video conferencing session, receiving check packet data from the mobile devices, and selecting, using the processor, a mobile device to control the video conferencing as a main controller.

### CROSS-REFERENCE TO RELATED APPLICATION

This application claims priority from and the benefit under 35 U.S.C. §119(a) of Korean Patent Application No. 10-2012-0021502, filed on Feb. 29, 2012, which is incorporated herein by reference for all purposes as if fully set forth herein.

### BACKGROUND

1. Field

The following description relates to a mobile device capable of multi-party video conferencing and a control method thereof.

2. Discussion of the Background

In general, a multipoint control unit (MCU) connected to a communication network arranges connections among multiple terminals and controls a video conferencing session for a multi-party video conferencing. For example, as shown in FIG. 1A and FIG. 1B, an MCU is connected to a communication network, and a variety of communication devices, such as 3G phones, video phones, IP phones, and computers, may be connected to the MCU for a multi-party video conferencing.

The MCU receives video data and audio data from all the communication devices participating in the video conferencing, and transmits the video data and audio data to the communication devices.

Since the MCU has limited resources and fixed communication bandwidth, a bottleneck may be caused for video conferencing managed by the MCU if a plurality of communication devices request a video conferencing from the MCU. If the traffic for video conferencing services exceeds the MCU's capacity, the bottleneck phenomenon may be exacerbated and the quality of service for the video conferencing may be deteriorated.

The MCU operates in a centralized way in communicating with connected devices for video conferencing and the MCU transmits/receives video data and audio data to/from all communication devices. Thus, MCU's hardware performance may be required to be improved regularly in order to maintain communication quality and process a large amount of traffics. For the improvement of the MCU as an intermediate hub, the cost and development time may increase significantly.

In addition, since the MCU is expensive, it is mainly used for companies or organizations and ordinary users of mobile terminals may be inaccessible to such video conferencing systems. Further, since the MCU is typically installed at a specific place, available time and place for a multi-party video conferencing may be limited in conventional video conferencing system.

### SUMMARY

Exemplary embodiments of the present invention provide a mobile device and method for controlling a multi-party video conferencing.

Additional features of the invention will be set forth in part in the description which follows and, in part, will be apparent from the description, or may be learned by practice of the invention.

Exemplary embodiments of the present invention provide a mobile device to control a multi-party video conferencing including a processor to process video data to be sent to a counterpart mobile device participating in the multi-party video conferencing and to transmit the processed video data to the counterpart mobile device, and a control unit to select a counterpart mobile device to authorize a main control right for controlling the multi-party video conferencing among counterpart mobile devices participating in the multi-party video conferencing.

Exemplary embodiments of the present invention provide a method that uses a processor to determine a main controller of a video conferencing session including determining mobile devices for the video conferencing session, receiving check packet data from the mobile devices, and selecting, using the processor, a mobile device to control the video conferencing as a main controller.

Exemplary embodiments of the present invention provide a mobile device to control a multi-party video conferencing including a control unit to determine whether a communication environment value or a main controller capability index of the mobile device is less than or equal to a threshold value, and a processor to determine whether to execute a temporary main control right according to a determination that the communication environment value or the main controller capability index is less than or equal to the threshold value.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A and FIG. 1B are block diagrams illustrating a conventional system architecture for providing a multi-party video conferencing.

FIG. 2A is a block diagram illustrating a mobile device to control multi-party video conferencing according to an exemplary embodiment of the present invention.

FIG. 2B is a diagram illustrating a flow of video data and audio data during a multi-party video conferencing according to an exemplary embodiment of the present invention.

FIG. 2C is a flowchart illustrating a control method of a mobile device capable of multi-party video conferencing according to an exemplary embodiment of the present invention.

FIG. 3A and FIG. 3B are diagrams illustrating a method of selecting and changing a mobile device having a main control right according to an exemplary embodiment of the present invention.

FIG. 4 is a flowchart illustrating a method for switching a main control right among mobile devices participating in multi-party video conferencing according to an exemplary embodiment of the present invention.

FIG. 5A is a block diagram illustrating a method for determining a mobile device as a main controller for a multi-party video conferencing according to an exemplary embodiment of the present invention.

FIG. 5B is a flowchart illustrating a method of determining main controller switching according to an exemplary embodiment of the present invention.

FIG. 6 is a diagram illustrating a flow of video data and audio data according to an exemplary embodiment of the present invention.

FIG. 7A and FIG. 7B are diagrams illustrating a video conferencing screen on a mobile device according to an exemplary embodiment of the present invention.

FIG. 8 is a diagram illustrating a method for controlling a video conferencing among multiple video conferencing groups according to an exemplary embodiment of the present invention.

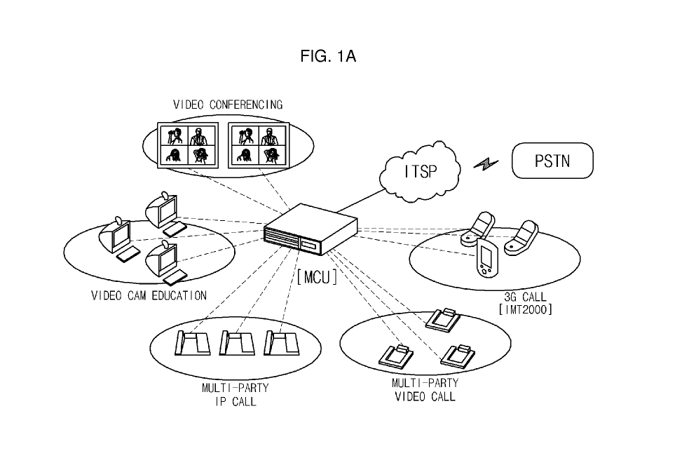

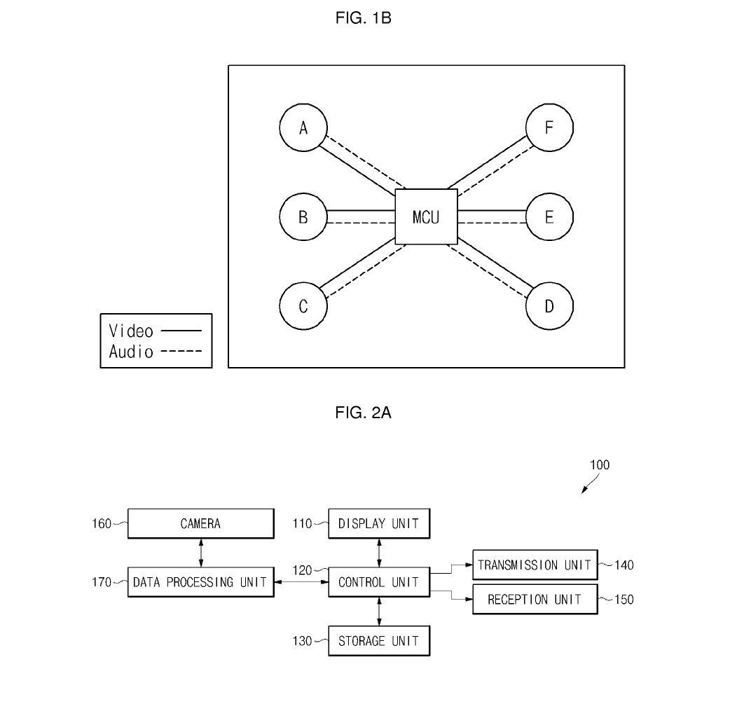

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

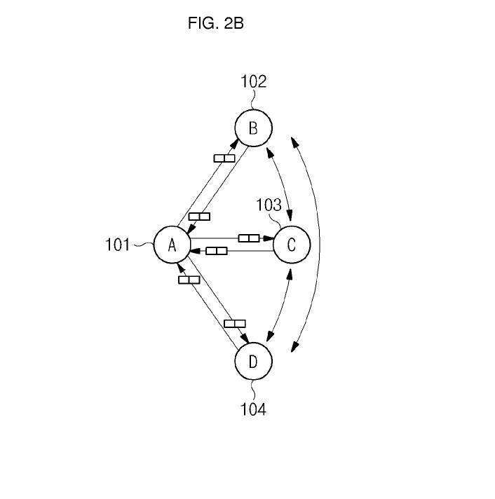

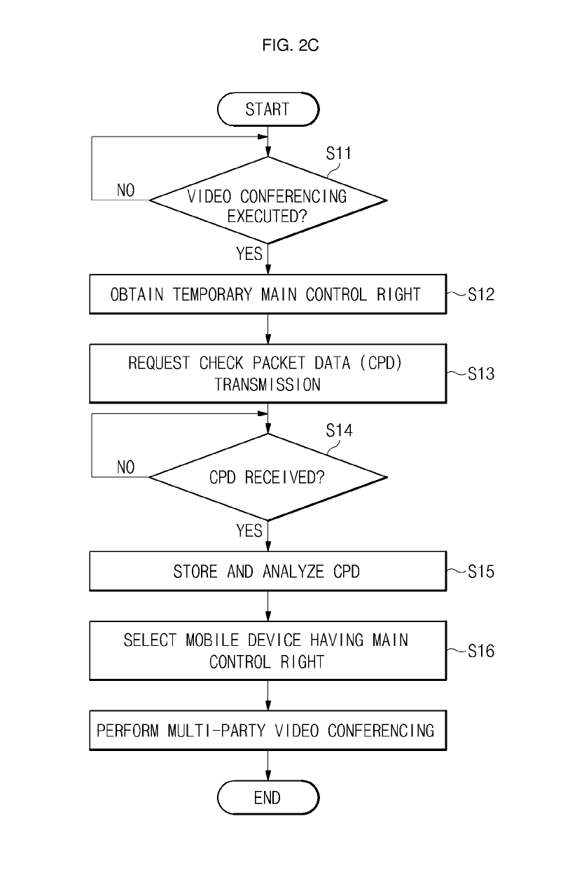

FIG. 2A is a block diagram illustrating a mobile device to control multi-party video conferencing according to an exemplary embodiment of the present invention.

Referring to FIG. 2A, a mobile device 100 includes a display unit 110, a control unit 120, and a storage unit 130. A transmission unit 140 and a reception unit 150 may be connected to the control unit 120. Further, the mobile device may include a camera 160 and a data processing unit 170.

The mobile device 100 may refer to a portable computer device capable of video calls, audio calls, internet search, and executing various application programs, and may include a display screen having a touch screen, or a small keyboard. For example, the mobile device 100 may be one of a smart phone having an enhanced computer function in addition to a call function, an Ultra Mobile Personal Computer (UMPC), a Personal Digital Assistant (PDA), and the like. Further, the mobile device 100 may include one or more processors, storage devices, transceivers, cameras, display panels, and other hardware/software components to implement the display unit 110, the control unit 120, the storage unit 130, the transmission unit 140, the reception unit 150, the camera unit 160, and/or the data processing unit 170.

The display unit 110 may display a video conferencing program icon or an application (e.g., a smart phone application) for multi-party video conferencing. The display unit 110 may display images of users participating in a video communication during a multi-party video conferencing, and display a speak request button for obtaining a right to speak. Furthermore, the display unit 110 may include a touch screen, and a video conferencing program icon or the speak request button may be selected through a touch input on the touch screen.

The control unit 120 may exchange data with the display unit 110, and may transmit a check packet data request message to another mobile device during a video communication. A video conferencing program icon to commence a video communication may be displayed after or before a call for video conferencing is made. If check packet data is received from another mobile device connected for the video communication, the control unit 120 may compare the check packet data to select a mobile device to receive a main control right for multi-party video conferencing, and to hand over the main control right to the selected mobile device. The mobile device that receives the main control right may perform operations of the multipoint controller (MC) and/or multipoint processors (MP) of the multipoint control unit (MCU). If a mobile device has a main control right, a control unit of the mobile device having the main control right may convert video and audio data encoded by various codecs and control traffic speed. Further, the control unit of the mobile device having the main control right may generate and control video conferencing sessions with respect to each mobile device participating in a video conferencing. Further, the control unit of the mobile device having the main control right may determine check packet data format differently according to the specification of each mobile device participating in a video conferencing. For example, if a mobile device supports LTE, the check packet data format may include a Reference Signal Received Power (RSRP) field. If a mobile device supports other communication protocols, a similar parameter field may be included in a check packet data.

The check packet data may be data about a communication environment of a mobile device. For example, the check packet data may include a communication type and electric field strength of a received signal, and the like. A mobile device may be selected as a main controller and receive a main control right from another mobile device to manage an established video communication session based on a comparison of the check packet data. If a mobile device serving as a main controller for an established video communication session, the mobile device may transfer the main controller role to another device which has a better or the highest main controller capability index (MCCI) or a better or the highest communication environment value. The communication condition may be evaluated according to a calculated value based on values included in the check packet data. Configurations of the check packet data and a selection method of a mobile device as a main controller to receive a main control right will be described in more detail.

The main control right may include a right for managing a multi-party video conferencing, such as receiving video data from another mobile device, reprocessing the received video data during a multi-party video conferencing, and transmitting the reprocessed video data to another mobile device. The reprocessing of video data may include resizing and modifying the video data into an appropriate format for the video conferencing. The mobile device serving as a main controller may perform similar functions of a typical multipoint control unit (MCU) for a video conferencing service. The main controller may convert video and audio data of different codecs into one format, control traffic of data, and may manage session with each connected mobile device.

The storage unit 130 may exchange data with the control unit 120, and store check packet data. The storage unit 130 may store its own identification value and communication environment value, and an identification value and a communication environment value of another mobile device obtained from received check packet data from another mobile device. Further, the control unit 120 may compare communication environment values of mobile devices including the communication environment value of the mobile device 100. The communication environment values may be digitized data. The communication environment value may have higher numerical value if a communication resource state is relatively good, and may have lower numerical value if the communication resource state is relatively bad.

The transmission unit 140 may exchange data with the control unit 120, and may transmit check packet data request message to another mobile device under the control of the control unit 120. The reception unit 150 may exchange data with the control unit 120, and may transfer check packet data request message received from another mobile device to the control unit 120 under the control of the control unit 120.

The camera 160 may capture a video image for multi-party video conferencing, convert the captured video image into video data, and transmit the converted video data to the data processing unit 170. The camera 160 may be equipped in the mobile device 100, and the resolution of the camera 160 may vary according to a hardware specification of a mobile device. Thus, a mobile device having a main control right may decode, resize, and/or process video data having various resolutions obtained from the camera 160 or from another mobile device to share the reprocessed video data among mobile devices participating in a multi-party video conferencing.

The data processing unit 170 may convert video data obtained from the camera 160 and video data transmitted from a first mobile device participating in a multi-party video conferencing, and may transmit the converted video data to a second mobile device participating in the multi-party video conferencing. The data processing unit 170 may be connected to the control unit 120. Video images captured by the camera 160 and video data transmitted from another mobile device may be processed in the data processing unit 170, and transmitted to another mobile device through the control unit 120 and the transmission unit 140, respectively. The video data transmitted from another mobile device may be transmitted to the data processing unit 170 through the reception unit 150 and the control unit 120.

The video data obtained from the camera 160 and the video data transmitted from another mobile device may be delivered to the display unit 110 through the control unit 120, so that the video from the camera 160 and the video transmitted from another mobile device are displayed together through the display unit 110.

The data processing unit 170 and the control unit 120 may be integrated into one integrated circuit. Further, some operations performed by the data processing unit 170 may be performed by the control unit 120, and vice versa.

Further, the mobile device 100 may include a microphone and a speaker for multi-party video conferencing. The microphone converts the voice of people participating in a multi-party video conferencing into audio data, i.e., an electrical signal, and the speaker converts the audio data, i.e., an electrical signal, into sound that people can hear and outputs the sound. Furthermore, the audio data may be processed into a desired format by the data processing unit 170.

FIG. 2B is a diagram illustrating a flow of video data and audio data during a multi-party video conferencing according to an exemplary embodiment of the present invention. Referring to FIG. 2B, a multi-party video conferencing may be held among a plurality of mobile devices 101, 102, 103, and 104. Although four mobile devices 101, 102, 103, and 104 are illustrated for a multi-party video conferencing as shown in FIG. 2B, the number of mobile devices may vary. In FIG. 2B, the first mobile device 101 has a main control right for a multi-party video conferencing. Video data and audio data may be transmitted/received between the first and second mobile devices 101, 102, the first and third mobile devices 101 and 103, and the first and fourth mobile devices 101 and 104. Unlike video data, audio data may be separately transmitted/received among mobile devices 101, 102, 103, and 104. Video data may be transmitted/received via a Long Term Evolution (LTE) network, and sound data may be transmitted/received via a third generation (3G) mobile communication network. Further, video and sound data may be transmitted/received via the same network and in the same route.

Hereinafter, a control method of a mobile device for multi-party video conferencing will be described.

FIG. 2C is a flowchart illustrating a control method of a mobile device capable of multi-party video conferencing according to an exemplary embodiment of the present invention. Referring to FIG. 2C, the control method of a mobile device for multi-party video conferencing may include determining whether a video conferencing is executed in operation S11, executing a temporary main control right and performing operations as a main controller in operation S12, sending a check packet data transmission request in operation S13, determining whether check packet data are received in operation S14, storing and analyzing the check packet data in operation S15, and selecting a mobile device having a main control right in operation S16. A mobile device initiating a video conferencing may perform the above operations by executing a video conferencing application. FIG. 2C will be described as if performed by the mobile device 100 shown in FIG. 2A, but is not limited as such.

In operation S11, the mobile device 100 may determine whether a video conferencing execution program icon or application displayed on the display unit 110 is executed, the video conferencing execution program icon may be displayed on the display unit 110 after or before a call for video conferencing is made. When executing a video conferencing execution program icon or application, a user may select other mobile devices to be invited in a video conferencing. After this operation, the mobile device 100 may have the temporary main control right in operation S12. Once the video conferencing begins, the camera 160 and the data processing unit 170 operate so that a video obtained from the camera 160 and video data transmitted from another mobile device are displayed on the display unit 110.

In operation S12, the mobile device 100 temporarily receives video and audio data from other mobile devices participating in the video conferencing, and decodes and reprocesses the received video and audio data to transmit the reprocessed video and audio data to other mobile devices according to the temporary main control right, and a multi-party video conferencing is initiated. The audio data may be separately transmitted/received among mobile devices from the video data.

In operation S13, the mobile device 100 may transmit a check packet data request message to mobile devices participating in the video conferencing, and receive check packet data from the mobile devices.

In operation S14, the mobile device 100 may determine whether check packet data are received from each of the mobile devices in response to the check packet data request message. If the check packet data are received from at least one of the mobile devices that receive the check packet data request message, the mobile device 100 may store and analyze the check packet data in operation S15.

In operation S15, the mobile device 100 stores the received check packet data and analyzes parameters included in the received check packet data. The mobile device 100 may calculates a main controller capability index based on the analyzed parameters.

For example, the check packet data may include an identification value and a communication environment value as parameters. The identification value may include an identification of a mobile device (ID) or an Internet Protocol (IP) address of the mobile device. The communication environment value may include at least one of a communication type, the electric field strength of a received signal (RX), a block error rate (BLER), an image resolution, an image format, and an image size. The block error rate is a value obtained by dividing the total sum of information delivery errors caused by a mobile device, i.e., a transmission medium, by the total sum of transmitted information. If an information unit of a target is a block, the error rate may be called a block error rate; if the information unit is a bit, the error rate may be called a bit error rate; and if the information unit is a character, the error rate may be called a character error rate.

Table 1 shows an example of check packet data information.

TABLE 1

| | Communication environment value | | | |
|---|---|---|---|---|
| Identification | Commu- | Electric field | Block | |
| value | nication | strength of | error | |
| or | type | received | rate | Image size |
| Identification IP | (CT) | signal (RX) | (BLER) | (IS) |
| 10.153.1.195 | LTE | −40 dB | 2% | 1280 × 960 |
| 10.153.1.055 | WCDMA | −85 dB | 5% | 640 × 480 |
| 10.153.1.175 | CDMA | −75 dB | 4% | 640 × 480 |
| 10.153.1.165 | WIFI | −60 dB | 3% | 320 × 240 |

The identification value may be used to recognize each mobile device. The communication environment value includes several fields, and a value indicating a field type may be used for distinguishing the value type.

The communication type (CT) in the communication environment value may be a field that may have the highest priority to select a main control right. Since capacity and speed of transmission may vary according to the communication type, a mobile device having a more evolved communication type may be more appropriate to have a main control right. LTE is the acronym for Long Term Evolution, WCDMA is the acronym for Wideband Code Division Multiple Access, CDMA is the acronym for Code Division Multiple Access, and WIFI is the acronym for Wireless Fidelity.

The electric field strength of a received signal (RX) in the communication environment value may be the electric field strength of a signal received through an antenna of a mobile device, and the measuring unit may be decibel (dB). As the electric field strength of a received signal is higher, a mobile device has a better chance to receive data with less error. The electric field strength of a received signal increases as its value increases to 0 from a negative value.

The block error rate (BLER) in the communication environment value numerically represents a rate at which errors occur while receiving data. The measuring unit of the block error rate may be represented by percentage (%). This block error rate is correlated with the electric field strength of a received signal, and may be inversely proportional to the electric field strength of a received signal. As the electric field strength of a received signal increases, the block error rate generally decreases.

The image size (IS) in the communication environment value may be a resolution of an image supported by a mobile device. The image size may be an allowable resolution range when a re-sized image is received by each mobile device during a multi-party video conferencing.

A communication network condition and the quality of communication of a mobile device may be determined according to various parameters in addition to the communication type. If a mobile device may be selected to have a main control right based on check packet data as shown in Table 1, each field may have a weight to determine a priority, and a main controller capability index (MCCI) may be calculated for each mobile device based on values included in the received check packet data.

The communication environment value may be represented by a numerical expression according to a predetermined function or rule. The communication environment value may be converted into a corresponding point. For example, for the communication type, 5 points, 4 points, and 3 points may be assigned to LTE, WIFI, and (W) CDMA, respectively. For the electric field strength of a received signal, 5 points, 4 points, and 3 points may be assigned to −40 dB to −70 dB, −71 dB to −100 dB, and below −101 dB, respectively. The points converted from the communication environment value may be determined as the MCCI if one communication environment value is considered. If more than one communication environment values are considered, the sum of the points converted from multiple communication environment values, the weighted sum of the points converted from multiple communication environment values, or the weighted sum of multiple communication environment values may be determined as the MCCI. In this manner, by obtaining an average value or total value of numerical values assigned to each of the fields as the MCCI, a mobile device having the highest MCCI may be selected to have a main control right for multi-party video conferencing. Further, the MCCI may be a weighted average value of numerical values assigned to each field or a weighted sum of the numerical values assigned to each field. A weight for each parameter to calculate an average value or a total value may be applied based on hardware/software specifications of participating mobile devices, and a relative capability as a main controller may be represented as the MCCI for each participating mobile device. Further, the MCCI may indicate a capability to convert the role of the mobile device into a main controller and to serve as a main controller. The mobile device having the highest value among the numerically measured communication environment values or the MCCI may be selected to have a main control right for multi-party video conferencing and the mobile device 100 may transmit control information for the video conferencing and information about participating mobile devices to the mobile device having the highest MCCI. The MCCI value may be determined at least one of communication environment values, such as CT, RX, BLER, IS, and the like.

The communication of the check packet data is different from a method of receiving a pilot signal via a pilot channel in various perspectives. Through the pilot channel, the electric field strength of a received signal may be measured for communication, for example, the electric field strength of a received signal between a base station and a mobile device. The measurement of the electric field strength of a received signal may be limited to one communication type that a mobile device uses.

Communication environment values (e.g., a communication type, the electric field strength of a received signal, a block error rate, and an image size) of each mobile device included in the check packet data may be used to evaluate network status of mobile devices utilizing different network types. As shown in Table 1, the network status of LTE with a first mobile device and the network status of WCDMA with a second mobile device may be evaluated and compared using the check packet data. The main control right may not be handed over to a mobile device that returns check packet data fastest, but may be handed over to a mobile device having the highest MCCI by evaluating various communication status parameters.

For example, if a mobile device A of a CDMA (3G) communication type has the best pilot status, a main control right for multi-party video conferencing may not be handed over to the mobile device A. Although a mobile device B of an LTE communication type has a lower Reference Signal Received Power (RSRP) than the pilot status of the mobile device A, the mobile device B may transmit and process a larger amount of data faster than the device A via an Orthogonal Frequency Division Multiplexing (OFDM) LTE communication type. Thus, a mobile device may be selected to receive the main control right by analyzing various parameters as shown in Table 1, for example.

In operation S16, the mobile device 100 may select a mobile device having the highest MCCI value and communicate with the mobile device having the highest MCCI value to hand over a main control right for multi-party video conferencing. An identification value or an IP address of each mobile device participating in the video conferencing may also be transmitted to the mobile device having the highest MCCI value for the continual operation of the multi-party video conferencing without interruption. If the mobile device 100 having a temporary main control right is determined to have the highest MCCI value than other mobile devices, the mobile device 100 having the temporary main control right continuously maintains the main control right.

The selection of a mobile device for transferring the main control right and a change of the main control right may not be recognized at a user side. For this continuous hand over procedure of main control right, the mobile device 100 may transmit control information and information of participating mobile devices to the mobile device having the highest MCCI while maintaining and controlling the existing video conferencing session, and the mobile device having the highest MCCI may initiate a session control environment to operate a video conferencing session. The main controller switching may be performed like a soft hand over procedure. Further, a mobile device may indicate a mobile device that has a main control right on a display unit.

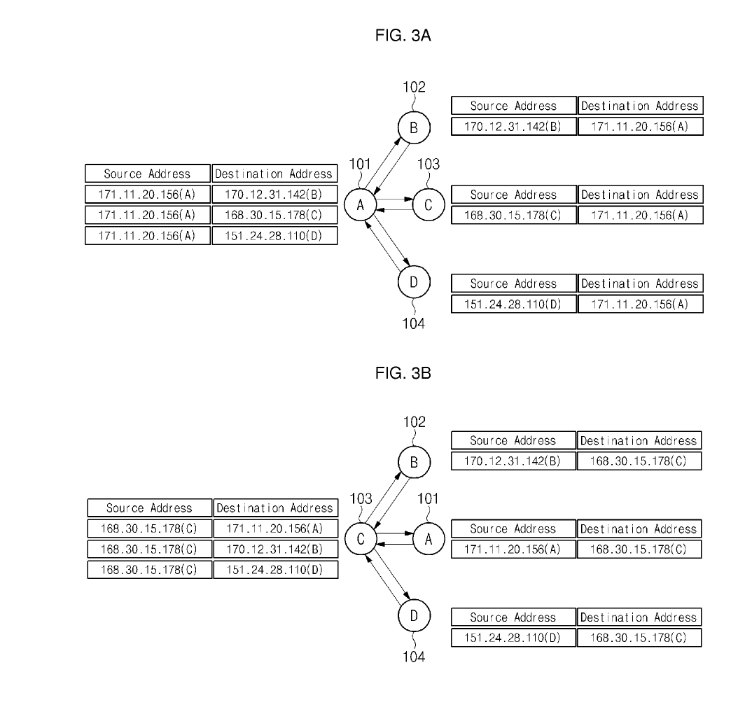

FIG. 3A and FIG. 3B are diagrams illustrating a method of selecting and changing a mobile device having a main control right according to an exemplary embodiment of the present invention.

FAs shown in FIG. 3A, a first mobile device 101 manages a multi-party video conferencing temporarily as a main controller for a multi-party video conferencing. The first mobile device 101 may store a source address and a destination address. The source address may be the address of the main controller, the address of the first mobile device 100, and the destination address may include an address of a participating mobile device, e.g., the addresses of second, third, and fourth devices 102, 103, and 104 that exchange video data and/or audio data. The source address and the destination address may be stored in the storage unit of the mobile device 101, the main controller.

Each of the second, third, and fourth devices 102, 103, and 104 having no main control right may store a source address and a destination address. For example, the second mobile device 102 stores its own address as the source address, and the address of the main controller, the first mobile device 101, as the destination address.

As shown in FIG. 3B, for example, if a main control right is handed over from the first mobile device 101 to the third mobile device 103, the first mobile device 101 transmits the destination addresses corresponding to the second and fourth devices 102 and 104 to the third mobile device 103, and transmits a message including information on main controller switching to the second and fourth mobile devices 102 and 104. The third mobile device 103 stores the destination addresses corresponding to the second and fourth mobile devices 102 and 104 in addition to the destination address corresponding to the address of the first mobile device 101.

The second and fourth mobile devices 102 and 104 having no main control right change stored destination address, i.e., from the address of the first mobile device 101 to the address of the third mobile device 103, and store the changed destination. Since the first mobile device 101 stores the address of the third mobile device 103 as a destination address, the first mobile device 101 may maintain the destination address.

As described above, each of the first, second, third, and fourth mobile devices 101, 102, 103, and 104 changes a source address and a destination address and stores the changed source address and the changed destination address in their own storage unit, so that a multi-party video conferencing may continue without interruption.

During a multi-party video conferencing, if the communication environment of a mobile device having a main control right deteriorates, the main control right may be handed over to another mobile device having a relatively excellent communication environment. The determination whether the communication environment is deteriorated may be determined based on the MCCI or one or more parameters of check packet data of the mobile device having the main control right. For example, if RX value decreases less than a triggering threshold value for requesting check packet data, e.g., −90 dB, the mobile device having the main control right may determine to seek another mobile device to transfer the main control right by requesting check packet data from other mobile devices. Further, if RX value decreases less than a switching threshold value for switching a main controller, e.g., −100 dB, the mobile device having the main control right may determine to transfer the main control right to another mobile device based on the received check packet data. The control unit 120 of the mobile device having the main control right may determine whether the value of MCCI or the value of one or more parameters decreases less than a threshold value and transmit check packet data request message to other mobile devices participating in the video conferencing to determine one mobile device to receive the main control right.

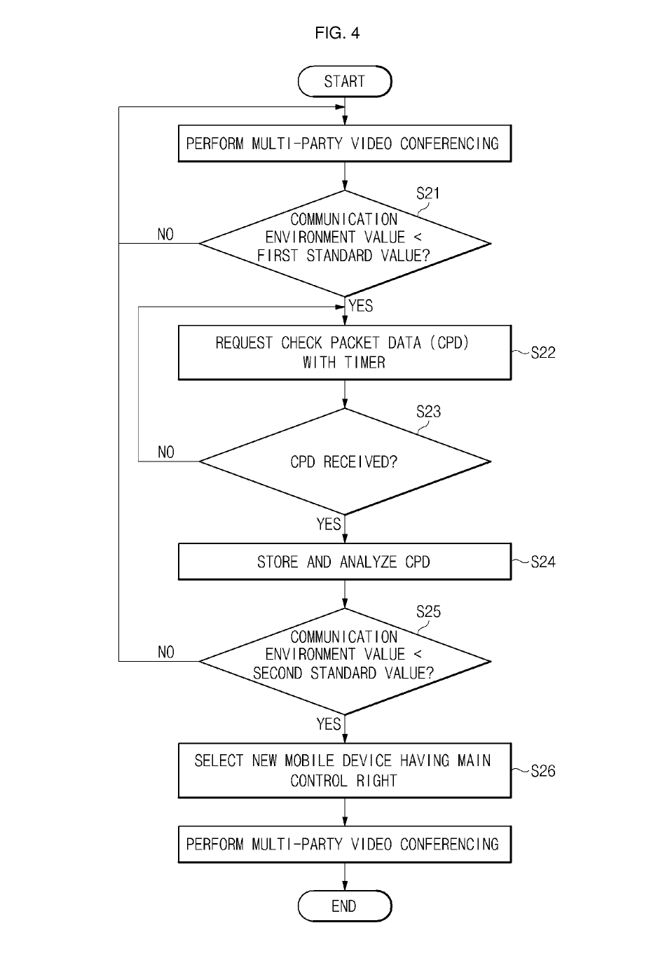

FIG. 4 is a flowchart illustrating a method for switching a main control right among mobile devices participating in multi-party video conferencing according to an exemplary embodiment of the present invention. As shown in FIG. 4, the method for switching a main control right may include determining whether a numerical communication environment value is less than a first standard value in operation S21, transmitting a check packet data request message with a timer in operation S22, determining whether check packet data are received or not in operation S23, storing and analyzing the check packet data in operation S24, determining whether an MCCI value or the communication environment value is less than a second standard value in operation S25, and selecting a new mobile device for transferring a main control right in operation S26.

In operation S21, a mobile device having a main control right may determine whether an MCCI or a communication environment value including at least one of a communication type, the electric field strength of a received signal, a block error rate, and an image size becomes less than a first standard value (the triggering threshold value). The determination may occur if the mobile device having the main control right moves from an LTE network to a 3G network, or the electric field strength of a received signal between a mobile device and a base station decreases, for example.

If a communication type of a mobile device changes from an LTE network into WIFI, the communication environment value may decrease from 5 points to 4 points as described above. If the first standard value is set as 4 points, the communication environment value may be regarded as less than or equal to the first standard value.

Further, if the electric field strength of a mobile device drops from −40 dB to −100 dB, as mentioned above, the communication environment value may be reduced from 5 points to 4 points. Likewise, if the first standard value is set as 4 points, the communication environment value may be regarded as less than or equal to the first standard value.

Further, the MCCI value determined by a weight allocated to a communication type or a weight allocated to the electric field strength of a received signal, or a total value or an average value calculated based on weights allocated to a communication type, the electric field strength of a received signal, a block error rate, and an image size may be compared with the first standard value.

Each mobile device may obtain a digitized value for each of the communication type, the electric field strength of a received signal, the block error rate, and the image size by using weights for each parameter, and compare the total value or average value of the digitized values with the first standard value to determine whether to transfer the main control right.

If the MCCI or the communication environment value becomes less than the first standard value, a mobile device having a main control right performs the transmitting of the check packet data request message with a timer in operation S22.

The timer may be a program command for transmitting check packet data from another mobile device to the mobile device having the main control right after a predetermined time elapses. The timer may be a program command like the check packet data request message, and be used to check a time elapse by using a clock signal that a mobile device provides, and execute a specific event if the predetermined time elapses. Further, the timer may serve as a trigger to transmit check packet data to a mobile device having a main control right periodically. Whenever the timer expires, the mobile device to which the timer and the check packet data request message is sent may transmit check packet data to the mobile device having the main control right and restart the timer. Thus, the check packet data may be transmitted periodically according to the length of the timer. The length of the timer may be set by the mobile device having the main control right. Furthermore, this timer may not be sent to mobile devices by a mobile device having a temporary main control right after a multi-party video conference is initiated.

In operation S23, the mobile device having the main control right may determine whether check packet data is received from another mobile device. If it is determined that the check packet data is received from all participating mobile devices, the storing and analyzing of the check packet data may be performed in operation S24.

In operation S24, the mobile device having the main control right may analyze received check packet data to determine which mobile device has the highest MCCI, and store the analyzed results. The check packet data may be received and stored periodically and statistical data may be generated based on accumulated data. For example, average MCCI may be calculated if multiple MCCIs are received from a mobile device during a certain period of time. Accordingly, communication environment and communication resource status of each mobile device may be more accurately analyzed based on the accumulated check packet data.

In operation S25, the mobile device having the main control right may determine whether the MCCI or the communication environment value becomes less than a second standard value (switching threshold value). The second standard value may be smaller than or equal to the first standard value.

For example, if a communication type of a mobile device changes from a WIFI network to WCDMA network, the communication environment value may change from 4 points to 3 points, for example. Accordingly, if the second standard value is set as 3 points, the communication environment value may be regarded as less than or equal to the second standard value.

Further, if the electric field strength of a mobile device drops from −100 dB to −150 dB, as mentioned above, the communication environment value may be reduced from 4 points to 3 points. If the second standard value is set as 3 points, the communication environment value may be regarded as less than or equal to the second standard value.

The communication environment value may be scaled by a weight allocated to a communication type or a weight allocated to the electric field strength of a received signal, and the MCCI value may be the communication environment value. Further, the MCCI value may be a total value or an average value calculated based on weights allocated to a communication type, the electric field strength of a received signal, a block error rate, and an image size.

If the communication environment value is less than or equal to the second standard value, the selecting of the new mobile device having a main control right may be performed in operation S26.

In operation S26, the mobile device having the main control right may select a new mobile device by using the MCCI value or the communication environment value obtained from each mobile device by analyzing the check packet data in operation S24. For example, a mobile device having the highest MCCI value or the highest communication environment value may be selected, and the main control right may be handed over to the mobile device having the highest MCCI value or the highest communication environment value.

The change of a main control right may include the above described two separate operations, 1) requesting check packet data, and 2) handing over the main control right. Thus, even if a communication environment of a mobile device having a main control right becomes drastically deteriorated, a multi-party video conference may continue without interruption because check packet data may be received and analyzed in advance when the MCCI or the communication environment value becomes less than or equal to the first standard value. If the check packet data request message is sent when the MCCI or the communication environment value becomes less than or equal to the second standard value, a communication environment may be deteriorated before a mobile device receives check packet data, so that the timing for changing the main control right may be delayed.

Further, once the MCCI value or the communication value decreases to a value between the first standard value and the second standard value, the MCCI value or the communication environment value may increase back to a value higher than the first standard value. Then, a timer stop message may be transmitted to the mobile devices to which check packet data request messages are sent to rescind the check packet data request. Thus, the mobile device having a main control right may not hand over the main control right to another mobile device, and continuously control a multi-party video conferencing.

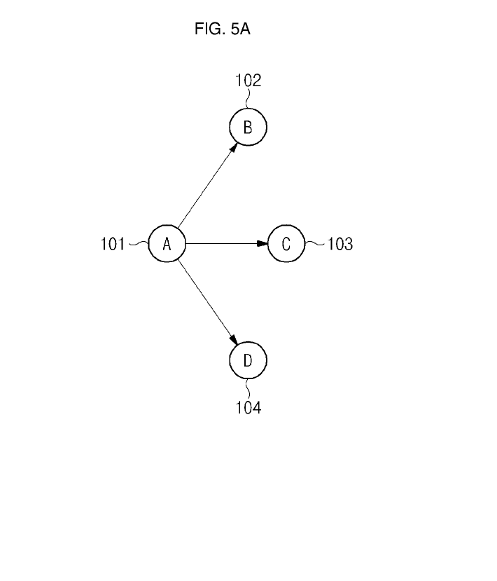

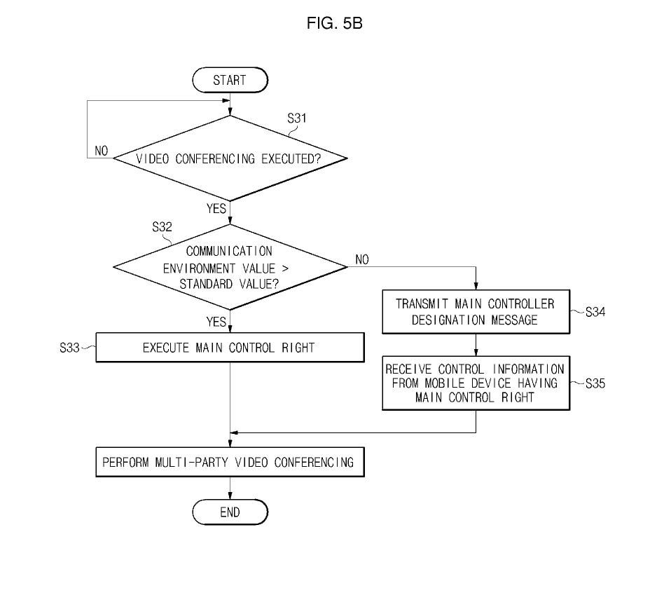

FIG. 5A is a block diagram illustrating a method for determining a mobile device as a main controller for a multi-party video conferencing according to an exemplary embodiment of the present invention, and FIG. 5B is a flowchart illustrating a method of determining main controller switching according to an exemplary embodiment of the present invention. As shown in FIG. 5B, a video conference program icon or application displayed on the display unit of the first mobile device 101 may be executed in operation S31. In operation S32, the first mobile device 101 may determine whether its own communication environment value or MCCI value is greater than a threshold value. For example, the first mobile device 101 may determine whether the RSRP of the first mobile device 101 is greater than −70 dB. The threshold value may be the first standard value or the second standard value described above or may be a third standard value.

If the communication environment value is greater than the standard value, the mobile device 101 has a main control right for multi-party video conferencing in operation S33, so that a multi-party video conference becomes available.

The above configuration and control method allow the mobile device 101 within a good communication environment to have a main control right for multi-party video conferencing, and stable communication quality may be secured from the beginning of the multi-party video conferencing while the mobile device 101 serves as a main controller. If the digitized communication environment value is smaller than the standard value, the video conferencing may not be executed, or only the audio data may be transmitted or received. Thus, video conferencing may not be initiated and an indication message that a video conferencing cannot be performed may be displayed on a screen of the mobile device 101 or an audio conferencing may be initiated. Further, if the communication environment value is smaller than the standard value, operations S 13 to S 16 shown in FIG. 2C may be performed, so that a mobile device having the highest communication environment value may have a main control right. For example, as shown in FIG. 5A and FIG. 5B, the mobile device 101 may transmit main controller designation message to mobile devices 102, 103, and 104 to be invited in a video conferencing in operation S34. The mobile device 101 or one of the mobile devices 102, 103, and 104 may have a temporary main control right if a communication environment value is greater than or equal to the standard value. The mobile device 101 may receive control information from the mobile device having the temporary main control right in operation S35 and a multi-party video conferencing may be initiated. One of the mobile devices 102, 103, and 104 may have a main control right if its communication environment value (or MCCI value) is a better or the highest value. The mobile device 101 may receive control information from the mobile device having the main control right in operation S35 and a multi-party video conferencing may be initiated. After the initiation of the multi-party video conferencing, the main controller designation procedure may be terminated. Further, each of the participating mobile devices may set the address of all participating mobile devices 101, 102, 103, and 104 except its own address as the destination address before deciding a mobile device as a main controller. For example, the mobile device 102 may set the addresses of participating mobile devices 101, 103, and 104 as the destination address before deciding a mobile device as a main controller. If a mobile device is authorized as a main controller by obtaining a main control right, the address of the mobile device may be set as new destination address for all participating mobile devices which do not have the main control right and the mobile device having the main control right may set the addresses of all other participating mobile devices as new destination addresses.

The RSRP is used as one example of a communication environment value or a MCCI value. Thus, the communication environment value may vary according to implementation needs.

Hereinafter, a flow of video data and audio data and a video image display method will be described.

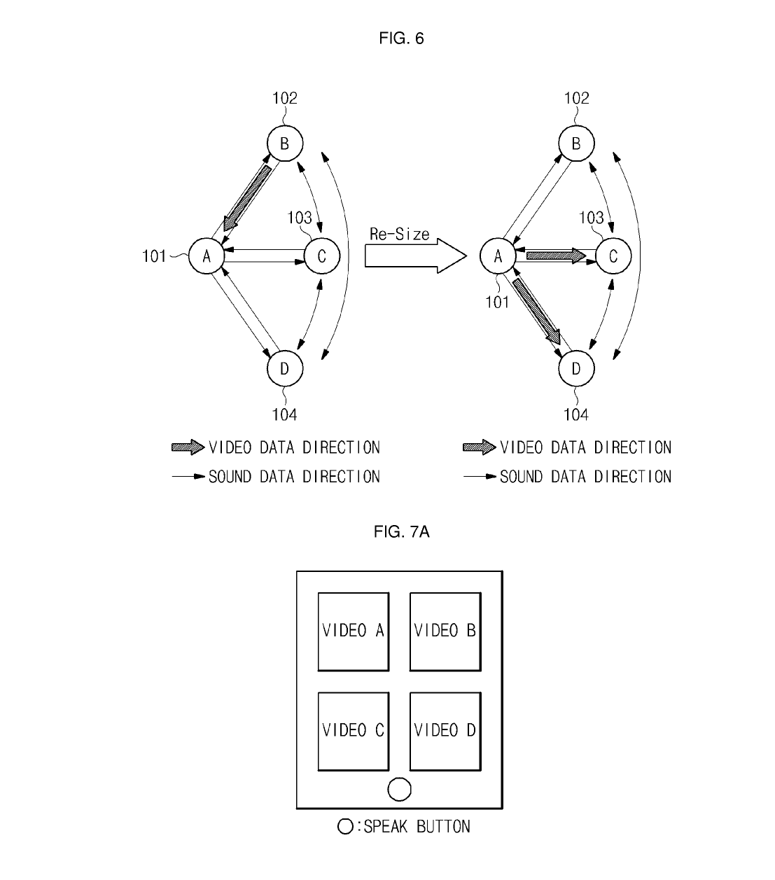

FIG. 6 is a diagram illustrating a flow of video data and audio data according to an exemplary embodiment of the present invention. For example, if the first mobile device 101 has a main control right for a multi-party video conferencing and the second mobile device 102 has the right to speak, video data and audio data may be transmitted from the second mobile device 102 to the first mobile device 101. Then, the first mobile device 101 may decode and process the video data and the audio data to transmit the decoded and processed data to the second and third mobile devices 103 and 104. The first and second mobile devices 101, 102, the first and third mobile devices 101 and 103, the first and fourth mobile devices 101 and 104, the second and third mobile devices 102 and 103, and the third and fourth mobile devices 103 and 104 may exchange audio data with each other separately as shown in FIG. 6. The first mobile device 101 having a main control right may select to process or control video data and audio data in a centralized way together, or to process or control the video data in a centralized way and let the audio data communicated locally.

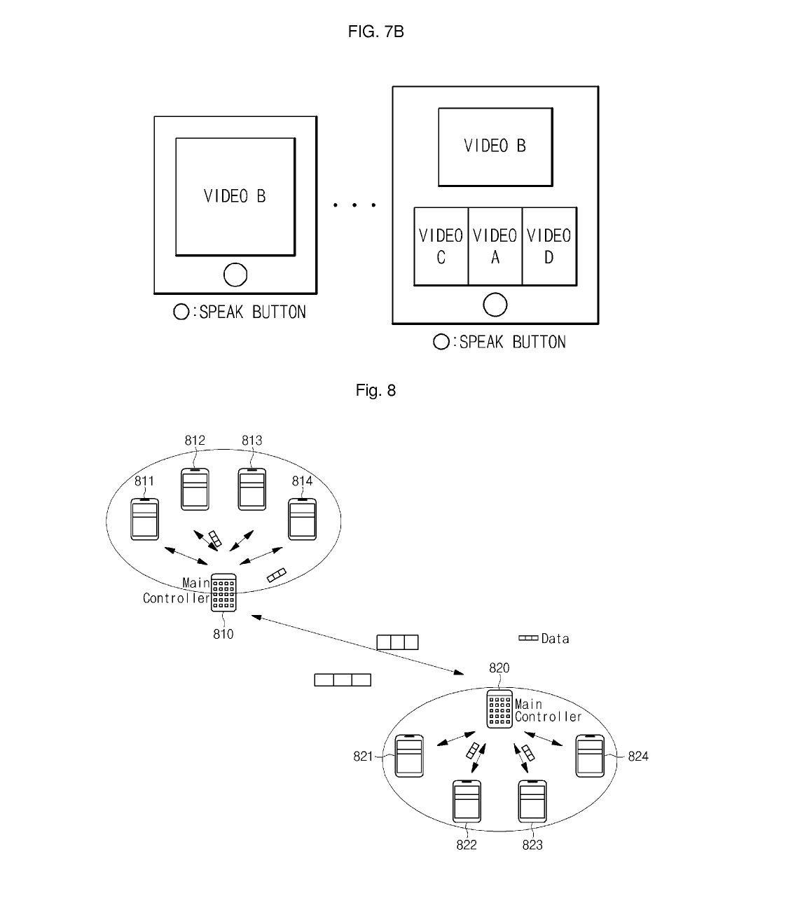

FIG. 7A and FIG. 7B are diagrams illustrating a video conferencing screen on a mobile device according to an exemplary embodiment of the present invention. As shown in FIG. 7A, once a multi-party video conferencing begins, display units of a mobile device having a main control right and mobile devices having no main control right may display video images of users participating in the multi-party video conferencing. The first mobile device having a main control right may receive video data from the second, third, and fourth mobile devices, and decode, resize, and encode the received video data to transmit the resized video data to the second, third, and fourth devices. The resized video data may vary according to the number of mobile devices participating in the video conferencing and the encoding procedure may be performed differently for each mobile device if each of the second, third, and fourth devices has different video conferencing configurations including codecs. Each display unit of the mobile devices may display a speak button. FIG. 7A is an exemplary view of a display screen when the speak button is not yet selected.

As shown in FIG. 7B, for example, if a user of the second mobile device selects the speak button, the second mobile device may have the right to speak and transmit its video data and audio data to the first mobile device having a main control right. Then, the first mobile device having the main control right may decode, resize, and encode the video data and transmit the resized video data to the third and fourth mobile devices. The screen at the left part of FIG. 7B may be provided to other mobile devices except for the first mobile device, and a screen at the right part of FIG. 7B may be provided to the first mobile device. A screen configuration displayed on the first mobile device may vary according to the number of mobile devices participating in the multi-party video conferencing.

FIG. 8 is a diagram illustrating a method for controlling a video conferencing among multiple video conferencing groups according to an exemplary embodiment of the present invention. As shown in FIG. 8, a mobile device 810 and a mobile device 820 may control separate video conferencing sessions and have a main control right for the corresponding video conferencing session. The mobile device 810 may control a first video conferencing group including participating mobile devices 811, 812, 813, and 814, and the mobile device 820 may control a second video conferencing group including participating mobile devices 821, 822, 823, and 824. During the two separate video conferencing sessions, the mobile device 810 and the mobile device 820 may share video conferencing information with each other. For example, the mobile device 810 may transmit first participant group information (mobile devices 811, 812, 813, and 814) to the mobile device 820, and the mobile device 820 may transmit second participant group information (mobile devices 821, 822, 823, and 824) to the mobile device 810. Further, the mobile devices 810 may control the mobile device 820 as a new participant and may control a video conferencing as if the mobile device 810 is controlling five participating mobile devices 811, 812, 813, 814, and 810. The mobile devices 821, 822, 823, and 824 may join the first video conferencing group via the mobile device 820. The mobile device 820 may serve as a bridge to the first video conferencing group. Similarly, the mobile device 820 may control mobile devices 821, 822, 823, 824, and 810 as participants of the second video conferencing group if the mobile device 810 accepts to join the second video conferencing group. The mobile devices 811, 812, 813, and 814 may join the second video conferencing group via the mobile device 810. The mobile device 810 may serve as a bridge to the second video conferencing group. If the mobile device 811 obtains the main control right for the first video conferencing group from the mobile device 810, the mobile device 811 may serve as a bridge to the second video conferencing group for the mobile devices 810, 812, 813, and 814.

According to exemplary embodiments of the present invention, a bottleneck phenomenon during a video conferencing may be avoided and the communication quality during a multi-party video conferencing may be enhanced by controlling a video conferencing under the main control right of a mobile device having the highest communication environment value, without connecting to a conventional MCU. Under the control of a mobile device having a high-performance hardware for a chip-set, an operating program, and a resolution, signal processing for a multi-party video conferencing may be performed without conventional MCU control.

Further, since conventional MCU can be eliminated from the system, additional hardware installation may be unnecessary, thereby reducing construction and maintenance costs for an MCU.

Further, a multi-party video conferencing may be performed with an enhanced mobility without an MCU, thereby time and space constraints may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile device to control a multi-party video conferencing, comprising:
a processor to process video data to be sent to a counterpart mobile device participating in the multi-party video conferencing, and to transmit the processed video data to the counterpart mobile device; and
a control unit to select a counterpart mobile device to authorize a main control right for controlling the multi-party video conferencing among counterpart mobile devices participating in the multi-party video conferencing.

2. The mobile device of claim 1, further comprising:
a transceiver to transmit a check packet data request message to the counterpart mobile devices participating in the multi-party video conferencing, and to receive check packet data from at least one of the counterpart mobile devices.

3. The mobile device of claim 2, wherein the check packet data comprises a communication environment value representing a status of a counterpart mobile device for controlling the multi-party video conferencing as a main controller.

4. The mobile device of claim 3, wherein the communication environment value comprises at least one of a communication type (CT), an electric field strength of a received signal (RX), a block error rate (BLER), and an image size (IS).

5. The mobile device of claim 3, wherein the control unit calculates a main controller capability index to determine a counterpart mobile device to receive the main control right based on a weighted sum of the communication environment value.

6. The mobile device of claim 2, wherein the transceiver transmits the check packet data request message if a communication environment value or a main controller capability index of the mobile device is less than or equal to a first threshold value.

7. The mobile device of claim 6, wherein the controller selects the counterpart mobile device to authorize the main control right if the communication environment value or the main controller capability index of the mobile device is less than or equal to a second threshold value.

8. The mobile device of claim 1, further comprising: a transceiver to transmit addresses or identifications of the counterpart mobile devices participating in the multi-party video conferencing to the counterpart mobile device authorized to have the main control right.

9. The mobile device of claim 1, wherein the control unit retains the main control right according to a communication environment value of the mobile device.

10. A method that uses a processor to determine a main controller of a video conferencing session, comprising:
determining mobile devices for the video conferencing session;
receiving check packet data from the mobile devices; and
selecting, using the processor, a mobile device to control the video conferencing as a main controller.

11. The method of claim 10, further comprising: transmitting a check packet data request message to the mobile devices for the video conferencing session, the check packet data request message comprising a communication environment value field determined according to resource information of a recipient of the check packet data request message.

12. The method of claim 10, wherein the check packet data comprises a communication environment value representing a status of a mobile device for controlling the video conferencing session as a main controller.

13. The method of claim 12, wherein the communication environment value comprises at least one of a communication type (CT), an electric field strength of a received signal (RX), a block error rate (BLER), and an image size (IS).

14. The method of claim 12, further comprising: calculating a main controller capability index for determining a mobile device to receive the main control right based on a weighted sum of the communication environment value.

15. The method of claim 11, wherein the check packet data request message is transmitted by a mobile device having a main control right.

16. The method of claim 11, wherein the check packet data request message is transmitted if a communication environment value or a main controller capability index of a mobile device having the main control right is less than or equal to a first threshold value.

17. The method of claim 16, wherein the mobile device to be authorized as the main controller is selected if the communication environment value or the main controller capability index is less than or equal to a second threshold value.

18. The method of claim 10, further comprising: transmitting addresses or identifications of mobile devices participating in the conferencing session to the mobile device authorized as the main controller.

19. The method of claim 10, wherein the main controller performs at least one of converting video or audio data into a different format, controlling traffic speed, generating a video conferencing session, and determining check packet data format.

20. A mobile device to control a multi-party video conferencing, comprising:
a control unit to determine whether a communication environment value or a main controller capability index of the mobile device is less than or equal to a threshold value; and
a processor to determine whether to execute a temporary main control right according to a determination that the communication environment value or the main controller capability index is less than or equal to the threshold value.

21. The mobile device of claim 20, wherein the mobile device executes the temporary main control right if the communication environment value or the main controller capability index is greater than the threshold value.

22. The mobile device of claim 20, further comprising: a transceiver to transmit a main controller designation message to another mobile device if the communication environment value or the main controller capability index is less than or equal to the threshold value.
